(19) United States
(12) Patent Application Publication
(10) Pub. No.: US 2007/0222930 A1
(43) Pub. Date: Sep. 27, 2007

(54) LIQUID CRYSTAL DISPLAY DEVICE

(76) Inventors: Tetsuo Fukami, Ishikawa-gun (JP); Kenji Nakao, Kanazawa-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/689,738

(22) Filed: Mar. 22, 2007

(30) Foreign Application Priority Data
Mar. 24, 2006 (JP) 2006-083229

(51) Int. Cl. G02F 1/1337

(52) U.S. Cl. 349/126

(57) ABSTRACT

A liquid crystal display device of an OCB mode includes a liquid crystal layer held between an array substrate and a counter-substrate, a display section composed of a plurality of display pixels arrayed in a matrix, and a peripheral section surrounding the display section. The array substrate includes pixel electrodes which are disposed in association with the plurality of display pixels. The counter-substrate includes a counter-electrode which is opposed to the plurality of pixel electrodes. The liquid crystal display device includes a pair of alignment films which are disposed on the plurality of pixel electrodes and the counter-electrode, respectively, the pair of alignment films controlling, by rubbing treatment, an alignment state of liquid crystal molecules included in the liquid crystal layer. The peripheral section includes a splay region, which splay-aligns the liquid crystal molecules, at least on a terminal-end side in a rubbing direction of the alignment film.

### CROSS-REFERENCE TO RELATED APPLICATIONS

This application is based upon and claims the benefit of priority from prior Japanese Patent Application No. 2006-083229, filed Mar. 24, 2006, the entire contents of which are incorporated herein by reference.

### BACKGROUND OF THE INVENTION

1. Field of the Invention

The present invention relates generally to a liquid crystal display device, and more particularly to an active-matrix liquid crystal display device.

2. Description of the Related Art

In general, a liquid crystal display device has a liquid crystal display panel including a display section on which an image is displayed. The liquid crystal display panel includes a pair of substrates which are opposed to each other. A liquid crystal layer is held between the pair of substrates.

One of the substrates includes a plurality of pixel electrodes which are arrayed substantially in a matrix. The other substrate includes a counter-electrode which is opposed to all the pixel electrodes. A pair of alignment films for aligning a liquid crystal are disposed, respectively, on the pixel electrodes and the counter-electrode.

The alignment state of the liquid crystal is obtained by controlling the orientation of liquid crystal molecules on the pair of alignment films. A rubbing method, for instance, is known as a method for controlling the orientation of liquid crystal molecules. In the rubbing method, the surfaces of the alignment films are rubbed by a rubbing cloth. Thus, the average direction of major axes of liquid crystal molecules is controlled by the rubbing treatment.

As a display mode of a liquid crystal display device, an OCB (Optically-Compensated-Birefringence) mode has attracted special attention from the standpoint of high responsivity and a wide viewing angle. A driving method in which display is effected on the basis of a non-video signal and a video signal in 1 frame is applied to the OCB mode liquid crystal display device, thereby to enhance the quality of video.

When this driving method is applied, a flow occurs in the liquid crystal layer due to a variation in alignment of liquid crystal molecules in the same direction as the rubbing direction of the alignment films. In addition, in the assembly process of the liquid crystal, there arises such a case that ions are taken in, or the material itself of, e.g. a glass substrate, which is a structural component of the liquid crystal display device, contains ions. In a part where ions are present, a liquid crystal alignment according to design cannot be obtained, and a display defect, such as non-uniform display, may occur.

In the prior art, in order to cope with the problem that spacers, such as beads, and impurity ions are moved by a flow due to a variation in alignment of liquid crystal molecules in an OCB mode liquid crystal display device, there has been proposed an invention which provides a liquid crystal display device wherein impurity ions are attracted to an ion trap electrode which is provided on a peripheral section surrounding a display section, thereby preventing occurrence of a display defect such as non-uniform display (see Jpn. Pat. Appln. KOKAI Publication No. 9-54325).

In this prior-art invention, however, no consideration is given to the rubbing direction of the alignment film, and it is difficult to effectively suppress a display defect due to ions which move in the rubbing direction. Moreover, in the peripheral section, if a predetermined DC voltage, at which liquid crystal molecules are set in a bend alignment, is applied to the liquid crystal layer, the viscosity of the liquid crystal layer increases.

Consequently, diffusion of the liquid crystal layer may hardly occur in the peripheral section, and impurity ions, which have moved in one direction due to the flow of the liquid crystal layer, may not move to the peripheral section and may agglomerate in the vicinity of a boundary with the peripheral section of the display section.

In the region where agglomeration of ions has occurred, the transmittance/application voltage characteristics of the liquid crystal layer vary due to the ions. In particular, in the case where the transmittance/application voltage characteristics of the liquid crystal layer vary in the display section, such a variation may be recognized as non-uniform display, or the like.

### BRIEF SUMMARY OF THE INVENTION

The present invention has been made in consideration of the above-described problems, and the object of the invention is to provide an OCB mode liquid crystal display device which suppresses a display defect, such as non-uniform display, due to non-uniformity of ions in a liquid crystal layer, and has high display quality and high reliability.

According to an aspect of the present invention, there is provided a liquid crystal display device of an OCB mode comprising a liquid crystal layer held between a first substrate and a second substrate, a display section composed of a plurality of display pixels arrayed in a matrix, and a peripheral section surrounding the display section, wherein the first substrate includes pixel electrodes which are disposed in association with the plurality of display pixels, the second substrate includes a counter-electrode which is opposed to the plurality of pixel electrodes, the liquid crystal display device includes a pair of alignment films which are disposed on the plurality of pixel electrodes and the counter-electrode, respectively, the pair of alignment films controlling, by rubbing treatment, an alignment state of liquid crystal molecules included in the liquid crystal layer, and the peripheral section includes a splay region, which splay-aligns the liquid crystal molecules, at least on a terminal-end side in a rubbing direction of the alignment film.

According to another aspect of the present invention, there is provided a liquid crystal display device of an OCB mode comprising a liquid crystal layer held between a first substrate and a second substrate, a display section composed of a plurality of display pixels arrayed in a matrix, and a peripheral section surrounding the display section, wherein the first substrate includes pixel electrodes which are disposed in association with the plurality of display pixels, and a driver or a connection part of the driver, which is disposed in the peripheral section, the second substrate includes a counter-electrode which is opposed to the plurality of pixel electrodes, the liquid crystal display device includes a pair of alignment films which are disposed on the plurality of pixel electrodes and the counter-electrode, respectively, the pair of alignment films controlling, by rubbing treatment, an alignment state of liquid crystal molecules included in the liquid crystal layer, and a direction of the rubbing treatment of the alignment film extends from a first end side, where the driver or the connection part of the driver is disposed, toward a second end side where neither the driver nor the connection part of the driver is disposed, and an angle between the direction of the rubbing treatment and a line perpendicular to the second end side is within a range of 45°.

The present invention can provide an OCB mode liquid crystal display device which suppresses a display defect, such as non-uniform display, due to non-uniformity of ions in a liquid crystal layer, and has high display quality and high reliability.

Additional objects and advantages of the invention will be set forth in the description which follows, and in part will be obvious from the description, or may be learned by practice of the invention, The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 schematically shows an example of the structure of a liquid crystal display panel of a liquid crystal display device according to an embodiment of the present invention;

FIG. 2 shows an example of a cross section of a display section of the liquid crystal display panel shown in FIG. 1;

FIG. 3 is a view for explaining the alignment state of liquid crystal molecules in an OCB mode liquid crystal display device;

FIG. 4 is a view for explaining an example of the structure of a liquid crystal display panel of a liquid crystal display device according to a first embodiment of the invention;

FIG. 5 shows an example of a cross section, taken along line A-A in FIG. 4, of the region of a boundary between the display section and peripheral section of the liquid crystal display panel shown in FIG. 4;

FIG. 6 is a view for describing an example of the structure of a liquid crystal display panel of a liquid crystal display device according to a second embodiment of the invention;

FIG. 7 shows an example of a cross section, taken along line B-B in FIG. 6, of the region of a boundary between the display section and peripheral section of the liquid crystal display panel shown in FIG. 6;

FIG. 8 is a view for describing an example of the structure of a liquid crystal display panel of a liquid crystal display device according to a third embodiment of the invention;

FIG. 9 shows an example of a cross section, taken along line C-C in FIG. 8, of the region of a boundary between the display section and peripheral section of the liquid crystal display panel shown in FIG. 8;

FIG. 10 is a view for explaining an example of the range of directions in which an alignment film of a liquid crystal display panel of a liquid crystal display device according to a fourth embodiment of the invention can be rubbed;

FIG. 11 is a view for explaining an example of the range of directions in which the alignment film of the liquid crystal display panel of the liquid crystal display device according to the fourth embodiment of the invention can be rubbed;

FIG. 12 is a view for explaining the range of directions in which the alignment film can be rubbed in the liquid crystal display panel of the liquid crystal display device according to the fourth embodiment of the invention;

FIG. 13 is a view for explaining the range of directions in which the alignment film can be rubbed in the liquid crystal display panel of the liquid crystal display device according to the fourth embodiment of the invention; and

FIG. 14 is a view for explaining the range of directions in which the alignment film can be rubbed in the liquid crystal display panel of the liquid crystal display device according to the fourth embodiment of the invention.

### DETAILED DESCRIPTION OF THE INVENTION

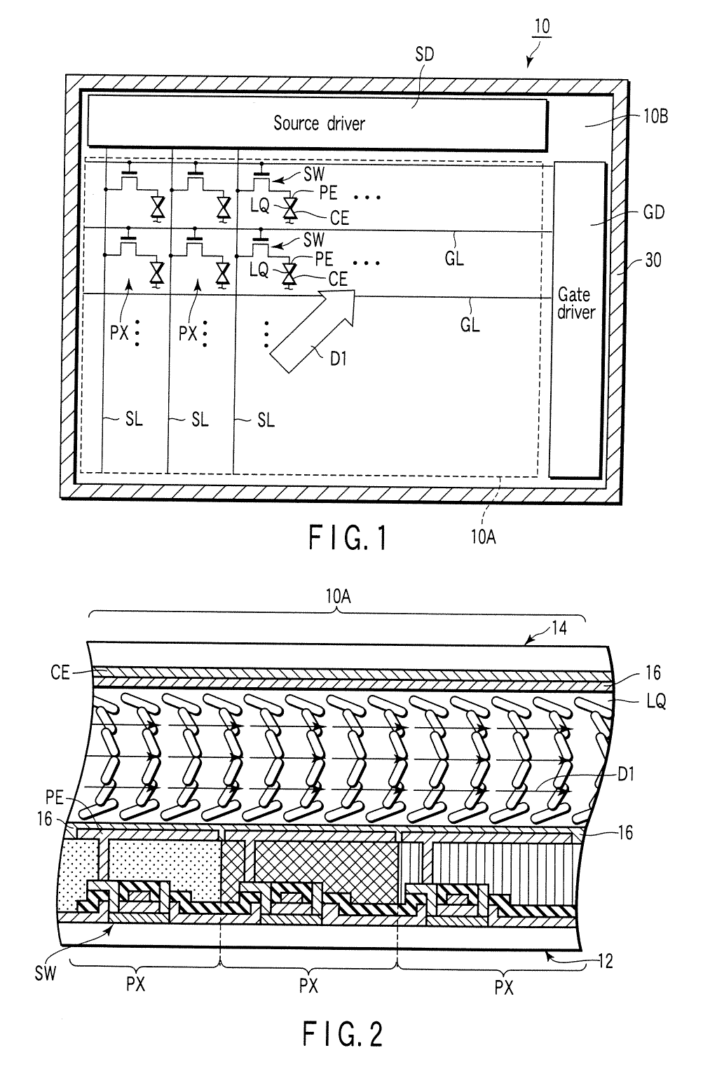

A liquid crystal display device according to a first embodiment of the present invention will now be described with reference to the accompanying drawings. The liquid crystal display device according to the first embodiment of the invention includes an OCB mode liquid crystal display panel 10, as shown in FIG. 1 and FIG. 2. The liquid crystal display panel 10 has a substantially rectangular plate shape, and includes a display section 10A which is composed of a plurality of display pixels PX that are arrayed in a matrix, and a peripheral section 10B which surrounds the display section 10A.

In the display section 10A, a plurality of scanning lines GL are disposed along rows in which a plurality of display pixels PX are arranged, and a plurality of signal lines SL are disposed along columns in which the display pixels PX are arranged. The plural scanning lines GL are connected to a gate driver GD which is disposed in the peripheral section 10B. The plural signal lines SL are connected to a source driver SD which is disposed in the peripheral section 10B.

The liquid crystal display panel 10 includes a pair of substrates which are opposed to each other, that is, an array substrate 12 and a counter-substrate 14. The array substrate 12 and counter-substrate 14 are fixed by a seal material 30 which is disposed along the peripheral parts of the array substrate 12 and counter-substrate 14. A liquid crystal layer LQ is held between the array substrate 12 and counter-substrate 14 in the region surrounded by the seal material 30.

The array substrate 12 has pixel electrodes PE which are arranged in association with the plural display pixels PX. A pixel switch SW, which is composed of, e.g. a thin-film transistor (TFT), is connected to each pixel electrode PE. Specifically, the gate electrode of the pixel switch SW is connected to the associated scanning line GL (or formed integral with the scanning line GL). The source electrode of the pixel switch SW is connected to the associated signal line SL (or formed integral with the signal line SL). The drain electrode of the pixel switch SW is connected to the associated pixel electrode PE which is disposed in the associated display pixel PX.

The signal lines GL are successively selected by the gate driver GD, and image data, which is output from the source driver SD, is applied to the pixel electrode PE via the pixel switch SW which is connected to the selected scanning line GL.

The counter-substrate 14 has a counter-electrode CE which is opposed to the plural pixel electrodes PE. In this embodiment, the counter-electrode CE is opposed to all the pixel electrodes PE.

In the array substrate 12 and counter-substrate 14, a pair of alignment films 16 are disposed on the pixel electrode PE and counter-electrode CE. The paired alignment films 16 are rubbed in a predetermined direction, and control the alignment state of liquid crystal molecules of the liquid crystal layer LQ. The liquid crystal molecules are aligned such that their major axes are substantially directed in the rubbing direction of the alignment films 16. In this embodiment, the alignment films 16 are subjected to rubbing treatment in a direction D1 shown in FIG. 1.

In the liquid crystal display device to which the above-described OCB mode is applied, the liquid crystal molecules are set in a bend alignment, as shown in FIG. 3, when an image is displayed on the basis of a video signal. When black insertion driving is applied to this liquid crystal display device, alternate image display is executed in 1 frame on the basis of a video signal and a non-video signal (i.e. a signal corresponding to black display).

Specifically, at a timing of displaying an image, the liquid crystal molecules may take an alignment state between white display and black display as shown in FIG. 3. At a timing of black insertion, the liquid crystal molecules take an alignment state similar to the black display, as shown in FIG. 3, on the basis of a non-video signal.

As has been described above, the alignment state of the liquid crystal molecules varies between when the video signal is applied to the liquid crystal layer LQ and when the non-video signal is applied to the liquid crystal layer LQ. Owing to the repetition of the variation of the alignment state of liquid crystal molecules, a flow occurs in the liquid crystal layer LQ in the rubbing direction D1. If impurities, which are contained in, e.g. a glass substrate, are present as ions in the liquid crystal layer LQ, the ions move in the rubbing direction D1 in accordance with the flow occurring in the liquid crystal layer LQ.

The array substrate 12 include various wiring lines which are led out from the display section to the peripheral section. These wiring lines, in some cases, include a wiring line, for instance, a storage capacitance line Cs, which is opposed to the counter-electrode and to which a potential different from a potential applied to the counter electrode is applied.

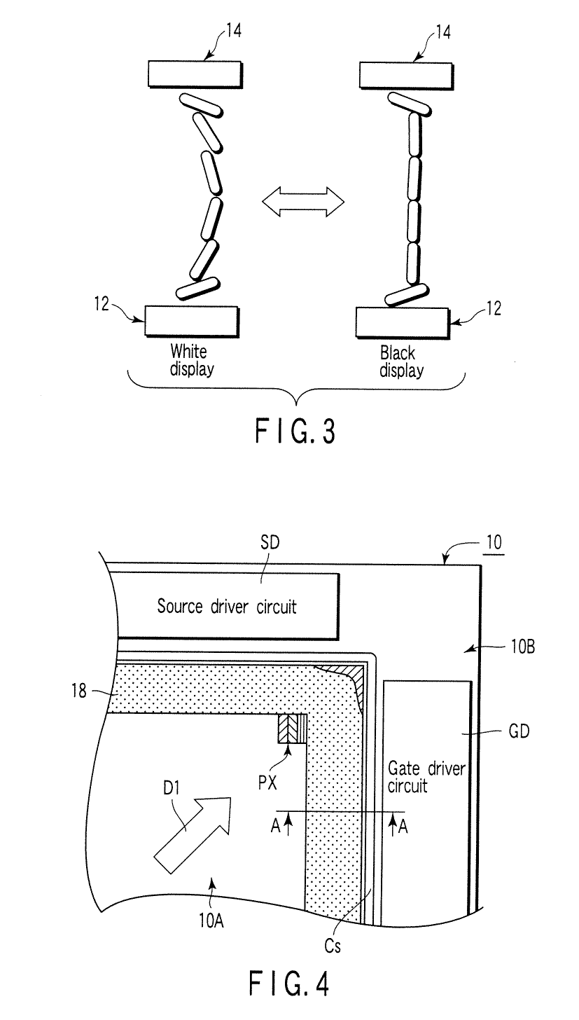

In a first embodiment shown in FIG. 4, the storage capacitance line Cs is disposed between the source driver SD and gate driver GD, on the one hand, and the display section 10A, on the other hand. In the case where the storage capacitance line Cs is supplied with such a voltage as to provide a sufficiently large fixed potential difference between the storage capacitance line Cs and the counter-electrode, the liquid crystal molecules of the liquid crystal layer LQ are set in a bend alignment, which corresponds to black display, between the array substrate and counter-substrate, and the liquid crystal molecules of the liquid crystal layer LQ are fixed in this alignment state.

As has been described above, in a bend region A2 in which liquid crystal molecules are fixedly set in the bend alignment, the viscosity of the liquid crystal layer LQ increases and a flow of the liquid crystal layer LQ hardly occurs. In other words, in the bend region A2, ions included in the liquid crystal layer LQ can hardly move. Consequently, if the bend region A2 is disposed near the display section 10A, the ions, which have moved in accordance with the flow of the liquid crystal layer LQ, tend to easily agglomerate on the terminal-end side in the rubbing direction D1.

To cope with this, in the present embodiment, the peripheral section 10B includes a splay region A1 for setting liquid crystal molecules in a splay alignment, at least on the terminal-end side in the rubbing direction D1 of the alignment film 16. In particular, in the first embodiment, the array substrate 12 includes, in the splay region A1, an electrically conductive layer 18 which is opposed to the counter-electrode CE and is set at a potential which is substantially equal to the potential of the counter-electrode CE.

In the embodiment shown in FIG. 4, the array substrate 12 includes the electrically conductive layer 18 which is disposed between the display section 10A and storage capacitance line Cs. The electrically conductive layer 18 is disposed, at least on the terminal-end side in the rubbing direction D1 of the alignment film 16, and is disposed in the vicinity of a boundary between the display section 10A and peripheral section 10B.

Since the voltage which is substantially equal to the voltage applied to the counter-electrode CE is applied to the electrically conductive layer 18, the region of the liquid crystal layer LQ between the electrically conductive layer 18 and counter-electrode CE becomes the play region A1 in which the liquid crystal molecules are splay-aligned. The flow of the liquid crystal layer LQ is maintained in the splay region A1, but the flow hardly occurs in the bend region A2 since the viscosity of the liquid crystal in the bend region A2 is high.

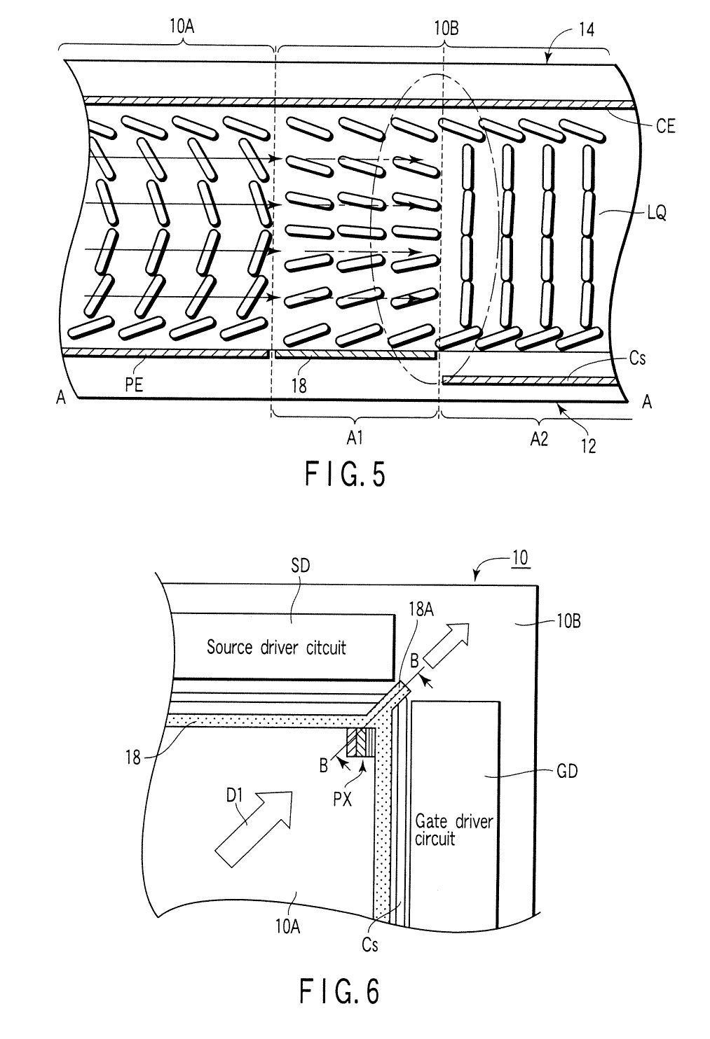

If ions move due to the flow of the liquid crystal layer to the vicinity of the boundary between the display section 10A and peripheral section 10B, the ions are diffused in the play region A1 of the peripheral section 10B, as shown in FIG. 5. Further, if the diffused ions move to the vicinity of the boundary between the splay region A1 and bend region A2, the ions agglomerate in the vicinity of the boundary between the splay region A1 and bend region A2 since the flow of the liquid crystal layer LQ ceases in the bend region A2.

In short, according to the above-described liquid crystal display panel 10, ions agglomerate in the peripheral section 10B, but no ions in the liquid crystal layer LQ agglomerate in the display section 10A. Hence, the ions in the liquid crystal layer LQ do not become non-uniform in the display section 10A.

Therefore, the first embodiment can provide an OCB mode liquid crystal display device which suppresses a display defect, such as non-uniform display, due to non-uniformity of ions in the liquid crystal layer, and has high display quality and high reliability.

In order to effectively suppress agglomeration of ions in the display section 10A, it is preferable to set the area of the electrically conductive layer 18 at 0.13% or more of the area of the display section 10A. In particular, it is preferable to dispose the electrically conductive layer 18 near the corner of the display section 10A, which corresponds to the terminal-end side in the rubbing direction D1.

Next, a liquid crystal display device according to a second embodiment of the invention is described with reference to the accompanying drawings. In the description of the second embodiment, the structural parts common to those of the liquid crystal display device according to the above-described first embodiment are denoted by like reference numerals, and a description thereof is omitted.

As shown in FIG. 6, the array substrate 12 includes an electrically conductive layer 18, at least on the terminal-end side in the rubbing direction of the peripheral section 10B. Like the above-described first embodiment, the electrically conductive layer 18 is disposed between the display section 10A and storage capacitance line Cs, and is also disposed near the boundary between the display section 10A and peripheral section 10B. In addition, a voltage, which is substantially equal to the voltage applied to the counter-electrode CE, is applied to the electrically conductive layer 18. In short, the splay region is disposed between the display section and the bend region.

In the second embodiment, the electrically conductive layer 18 includes a guide path which extends over the storage capacitance line to the outside of the bend region. Specifically, a guide path 18A is disposed on the counter-electrode CE side of the storage capacitance line Cs (i.e. on an insulation layer which covers the storage capacitance line). The guide path 18A extends from the corner of the electrically conductive layer 18, which is located on the terminal-end side in the rubbing direction D1, over the storage capacitance line Cs to the outside of the storage capacitance line Cs. A common electrode (not shown), which is set at a potential substantially equal to the potential of the counter-electrode CE, is disposed on the outside of the storage capacitance line Cs of the array substrate 12.

The guide path 18A is, for example, formed integral with the electrically conductive layer 18, and the guide path 18A, like the electrically conductive layer 18, is supplied with a voltage which is substantially equal to the voltage of the counter-electrode CE. Specifically, even in the case where a fixed voltage, which bend-aligns the liquid crystal molecules of the liquid crystal layer LQ, is applied to the storage capacitance line Cs, a potential difference between the guide path 18A and counter-electrode CE is applied to the liquid crystal layer LQ since the guide path 18A is disposed over the storage capacitance line Cs.

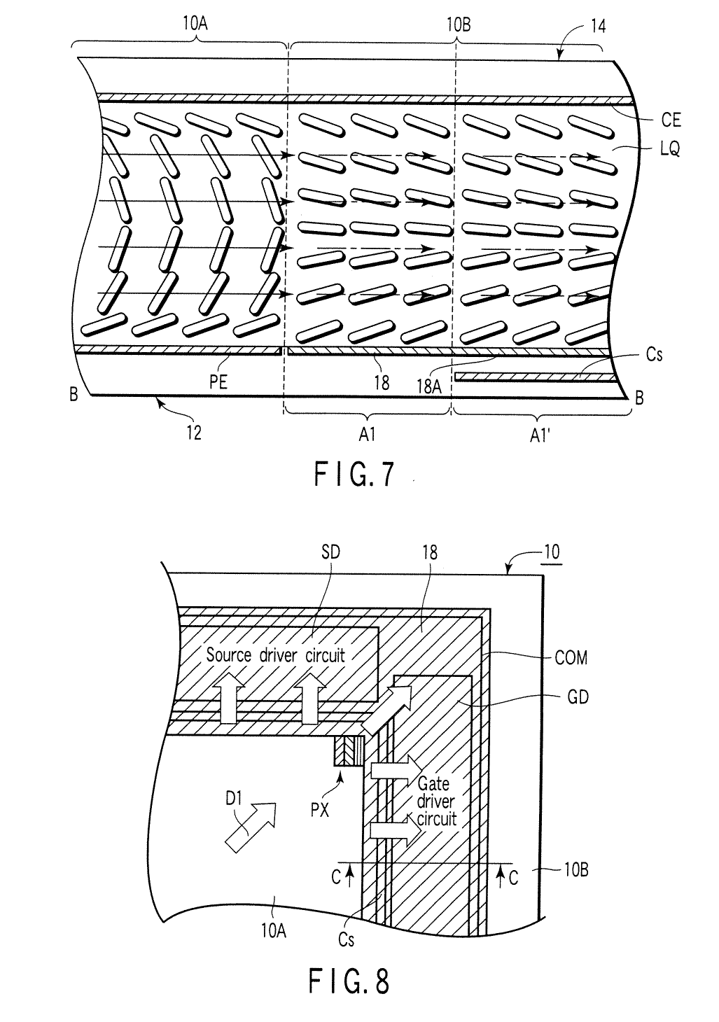

Accordingly, as shown in FIG. 7, a region of the liquid crystal layer LQ between the electrically conductive layer 18 and counter-electrode CE becomes a splay region A1 where liquid crystal molecules are splay-aligned. Similarly, a region of the liquid crystal layer LQ between the guide path 18A and counter-electrode CE becomes a splay region A1′ where liquid crystal molecules are splay-aligned.

To be more specific, the splay region A1′ is provided by the guide path 18A in a part of the bend region A2 that is provided by the storage capacitance line Cs. In addition, that part of the liquid crystal layer LQ, which is located outside the spay region A1′ that is provided by the guide path 18A, becomes a splay region between the common electrode (not shown) and the counter-electrode CE.

In the above-described liquid crystal display panel 10, if a flow of the liquid crystal layer LQ occurs along the rubbing direction D1, the ions in the liquid crystal layer LQ move to the vicinity of the boundary between the display section 10A and peripheral section 10B. The ions, which have moved to the vicinity of the boundary between the display section 10A and peripheral section 10B, are diffused from the display section 10A to the splay region A1 that is provided by the electrically conductive layer 18 of the peripheral section 10B. The ions, which have been diffused in the splay region A that is provided by the electrically conductive layer 18, pass through the splay region A1′ that is provided by the guide path 18A, and move to the splay region that is located outside the storage capacitance line Cs.

According to the above-described liquid crystal display panel 10, the ions in the liquid crystal layer LQ move to the outside of the storage capacitance line Cs through the splay region A1′ that is provided by the guide pass 18A. Hence, the ions in the liquid crystal layer LQ do not become non-uniform in the display section 10A.

Thus, the second embodiment can provide an OCB mode liquid crystal display device which suppresses a display defect, such as non-uniform display, due to non-uniformity of ions in the liquid crystal layer, and has high display quality and high reliability.

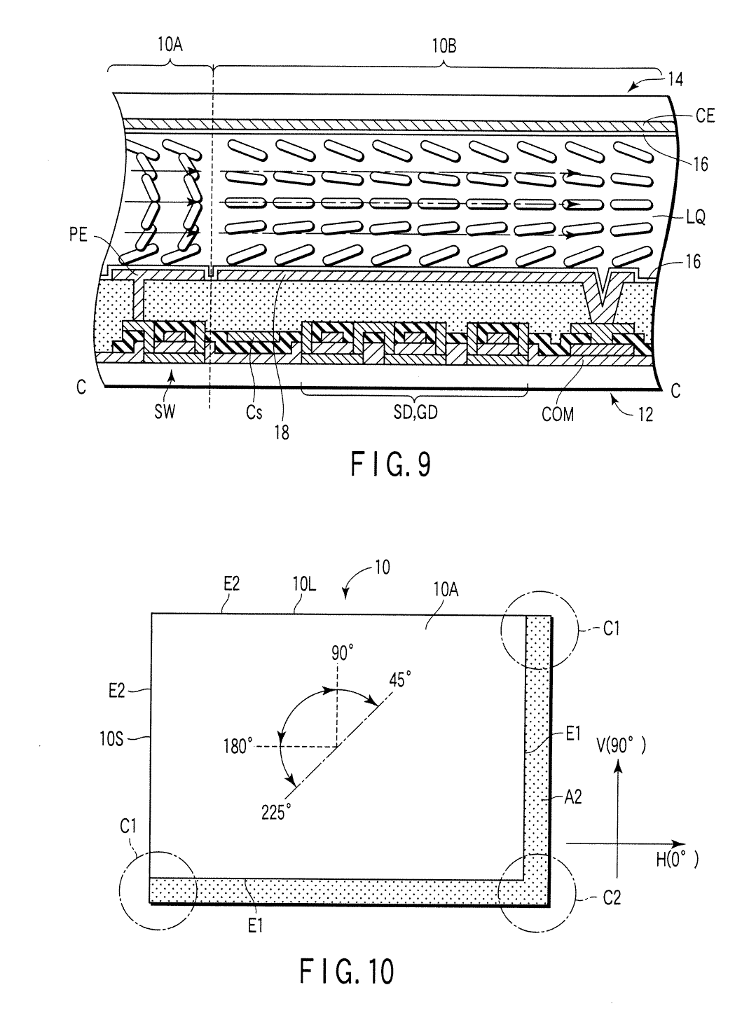

Next, a liquid crystal display device according to a third embodiment of the invention is described with reference to the accompanying drawings. As shown in FIG. 8 and FIG. 9, a liquid crystal display panel 10 of the liquid crystal display device according to the third embodiment includes an electrically conductive layer 18 in the peripheral section 10B of the array substrate 12. The array substrate 12 has the storage capacitance line Cs and driver GD, SD in the peripheral section 10B. A common electrode COM, which is set at a potential substantially equal to the potential of the counter-electrode CE, is disposed on the outside of the driver GD, SD.

The electrically conductive layer 18 is disposed on the counter-electrode CE side of the storage capacitance line Cs and driver GD, SD (i.e. on an insulation layer covering the storage capacitance line Cs and driver GD, SD). In addition, the electrically conductive layer 18 is disposed so as to extend from the vicinity of the boundary between the display section 10A and peripheral section 10B and to cover the storage capacitance line Cs and driver GD, SD. Further, the electrically conductive layer 18 is connected via a contact hole to the common electrode COM that is disposed in the peripheral section 10B. Accordingly, a voltage, which is substantially equal to the potential of the counter-electrode CE, is applied to the electrically conductive layer 18.

Specifically, even in the case where a fixed voltage, which bend-aligns the liquid crystal molecules of the liquid crystal layer LQ, is applied to the storage capacitance line Cs and driver GD, SD, a potential difference between the electrically conductive layer 18 and counter-electrode CE is applied to the liquid crystal layer LQ since the electrically conductive layer 18 is disposed over the storage capacitance line Cs and driver GD, SD.

In this embodiment, since the voltage equal to the voltage of the counter-electrode CE is applied to the electrically conductive layer 18, liquid crystal molecules are splay-aligned in the region of the liquid crystal layer LQ between the electrically conductive layer 18 and counter-electrode CE. In short, the region of the liquid crystal layer LQ between the electrically conductive layer 18 and counter-electrode CE becomes the splay region A1.

As shown in FIG. 9, due to the flow of the liquid crystal layer LQ in the rubbing direction D1, the ions in the liquid crystal layer LQ move to the vicinity of the boundary between the display section 10A and peripheral section 10B. The ions, which have moved to the vicinity of the boundary between the display section 10A and peripheral section 10B, are diffused into the splay region A1 that is provided by the electrically conductive layer 18 of the peripheral section 10B. The ions, which have been diffused in the splay region A1 that is provided by the electrically conductive layer 18, pass through the region where the storage capacitance line Cs and driver GD, SD are disposed, and move to the outside of the liquid crystal display panel 10.

According to the liquid crystal display device including the above-described liquid crystal display panel 10, the ions in the liquid crystal layer LQ move to the outside of the storage capacitance line Cs and driver GD, SD through the splay region A1 that is provided by the electrically conductive layer 18. Hence, the ions in the liquid crystal layer LQ do not become non-uniform in the display section 10A.

Thus, the third embodiment can provide an OCB mode liquid crystal display device which suppresses a display defect, such as non-uniform display, due to non-uniformity of ions in the liquid crystal layer, and has high display quality and high reliability.

Next, a fourth embodiment of the invention is described with reference to the accompanying drawings. A liquid crystal display device according to the fourth embodiment includes a substantially rectangular liquid crystal display panel 10. The liquid crystal display panel 10 includes pixel switches SW which are formed by using amorphous silicon (a-Si) material. A driver circuit or a connection part (not shown) of the driver circuit is disposed in the peripheral part 10B of the liquid crystal display panel 10.

In the case of the liquid crystal display device according to this embodiment, the driver circuit is disposed on the outside of the liquid crystal display panel 10, and wiring lines 19 for inputting driving signals from the driver circuit to the display section 10A are disposed in the peripheral section 10B.

The wiring lines 19 are disposed to be opposed to the counter-electrode. In the case where a voltage, which sets the liquid crystal molecules of the liquid crystal layer LQ in the bend alignment corresponding to black display, is applied to the wiring lines 19, the region between a region, where the wiring lines 19 of the array substrate 12 are disposed, and the counter-electrode CE of the counter-substrate 14 becomes a bend region A2. The region where the wiring lines 19 of the array substrate 12 are not disposed becomes a splay region A1. Specifically, the display section 10A has a first end side E1 where the driver circuit or the above-mentioned connection part is disposed, and a second end side E2 where neither of them is disposed.

In the present embodiment, the rubbing direction D1 of the alignment film is a direction extending from the first end side E1 to the second end side E2, and the angle between the rubbing direction D1 and a line perpendicular to the second end side E2 is within a range of 45°. Specifically, the rubbing direction D1 is set such that a component of a direction substantially perpendicular to the end side where the splay region A1 of the display section 10A is disposed becomes greater than a component of a direction substantially perpendicular to the end side where the bend region A2 is disposed.

It is now assumed that a direction parallel to a long side 10L of the liquid crystal display panel 10 is a horizontal axis H, a direction parallel to a short side 10S is a vertical axis V, and a positive direction of the horizontal axis H is a direction of 0°. As shown in FIG. 10, in the case where bend regions A2 are positioned along two neighboring sides of the display section 10A, that is, in the case where the present embodiment is applied to the liquid crystal display panel 10 in which driver circuits or connection parts of the driver circuits are disposed in the direction of 0° and the direction of 270°, the rubbing direction D1 of the alignment film is set in the range of 45° to 225° from the horizontal axis H.

In addition, as shown in FIG. 11, in the case where bend regions A2 are positioned along three neighboring sides of the display section 10A, that is, in the case where the present embodiment is applied to the liquid crystal display panel 10 in which driver circuits or connection parts of the driver circuits are disposed in the direction of 0°, the direction of 180° and the direction of 270°, the rubbing direction D1 of the alignment film is set in the range of 45° to 135°.

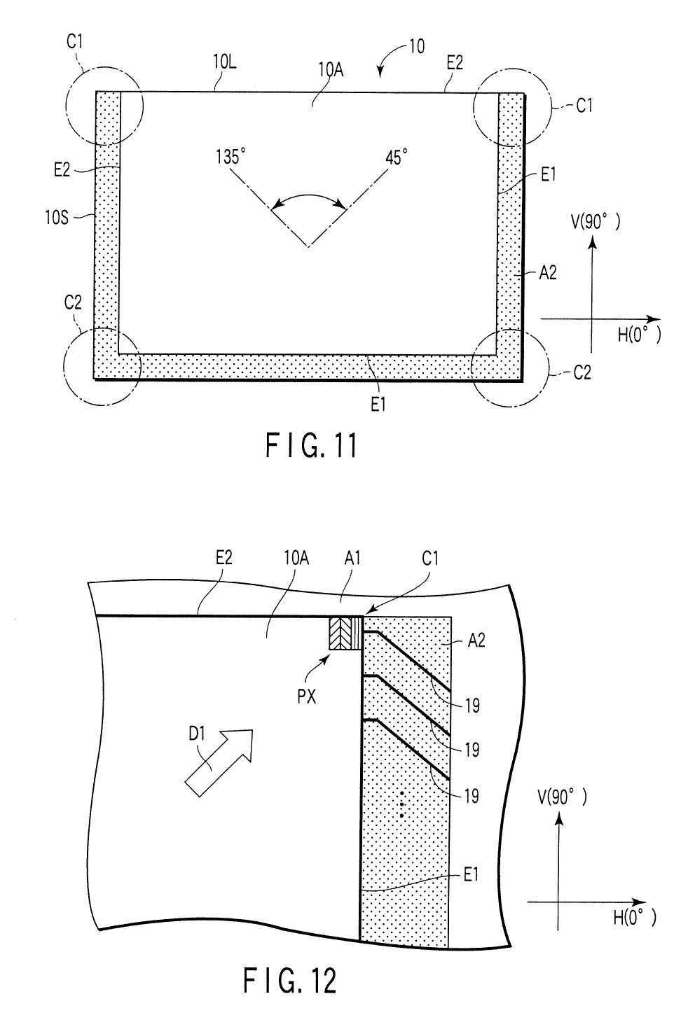

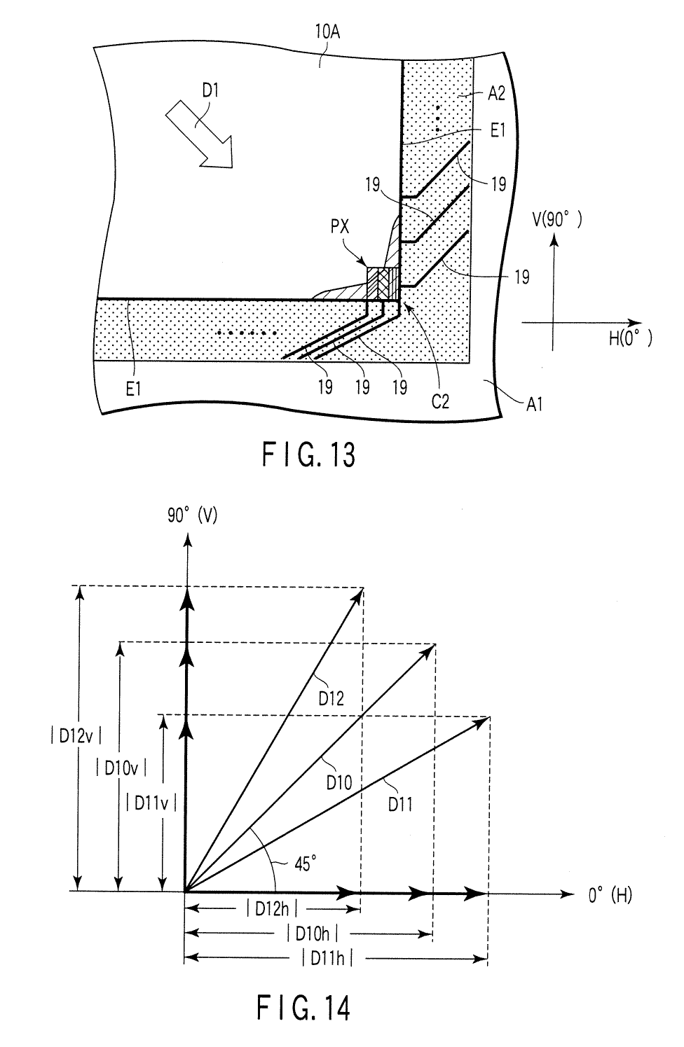

The reason for setting the range of angles of the rubbing direction D1, as described above, will now be explained with reference to FIG. 12 and FIG. 13. FIG. 12 shows the case in which the liquid crystal display panel 10 has a corner portion C1 at which end sides of the display section 10A intersect, and the bend region A2 is disposed in the peripheral section 10B along one of the end sides which intersect at the corner portion C1. In the case of the liquid crystal display panel 10 shown in FIG. 12, the bend region A2 is positioned in the direction of 0°.

Consideration is now given to the case where the alignment film of the liquid crystal display panel 10 is rubbed in a direction in the range of 0° to 90° from the horizontal axis H. At this time, the vertical axis V and the end side, on which the spray region A1 is disposed, are substantially perpendicular to each other, and the horizontal axis H and the end side, on which the bend region A2 is disposed, are substantially perpendicular to each other.

Consideration is given to the case where the alignment film of this liquid crystal display panel 10 is rubbed in a direction of, e.g. about 45° from the horizontal axis H. In this case, the rubbing direction D1 is a direction D10 shown in FIG. 14. At this time, ions in the liquid crystal layer LQ move along the direction D10. If a horizontal component D10h and a vertical component D10v of the direction D10 are compared, the magnitude |D10h| of the horizontal component D10h is equal to the magnitude |D10v| of the vertical component D10v, as shown in FIG. 14.

Specifically, if the rubbing direction D1 is set to the direction D10, the component of the direction, which is substantially perpendicular to the end side where the splay region A1 of the display section 10A is disposed, becomes equal to the component of the direction, which is substantially perpendicular to the end side where the bend region A2 is disposed. Thus, in this case, a force which moves the ions, which have already moved to the vicinity of the boundary between the display section 10A and peripheral section 10B, to the splay region A1 becomes equal to a force which moves the ions to the bend region A2.

Next, consideration is given to the case where the alignment film of this liquid crystal display panel 10 is rubbed in a direction of an angle less than 45° from the horizontal axis H. In this case, the rubbing direction D1 is, e.g. a direction D11 shown in FIG. 14. At this time, if the magnitude |D11h| of the horizontal component D11h of the direction D11 and the magnitude |D11v| of the vertical component D11v are compared, the horizontal component D11h is greater than the vertical component D11v, as shown in FIG. 14.

Specifically, as regards the direction D11, the component of the direction, which is substantially perpendicular to the end side where the splay region A1 of the display section 10A is disposed, becomes less than the component of the direction which is substantially perpendicular to the end side where the bend region A2 is disposed.

Thus, if the rubbing direction D1 is set to the direction D11, the force |D11h| which moves the ions, which have already moved to the vicinity of the boundary between the display section 10A and peripheral section 10B, to the bend region A2 is greater than the force |D11v| which moves the ions to the splay region A1. Hence, the ions can hardly move to the splay region A1.

Further, consideration is given to the case where the alignment film of this liquid crystal display panel 10 is rubbed in a direction of an angle greater than 45° from the horizontal axis H. In this case, the rubbing direction D1 is, e.g. a direction D12 shown in FIG. 14. At this time, if the magnitude |D12h| of the horizontal component D12h of the direction D12 and the magnitude |D12v| of the vertical component D12v are compared, the vertical component D12v is greater than the horizontal component D12h.

Specifically, as regards the direction D12, the component of the direction, which is substantially perpendicular to the end side where the splay region A1 of the display section 10A is disposed, becomes greater than the component of the direction which is substantially perpendicular to the end side where the bend region A2 is disposed.

Thus, if the rubbing direction D1 is set to the direction D12, the force |D12v| which moves the ions, which have already moved to the vicinity of the boundary between the display section 10A and peripheral section 10B, to the splay region A1 is greater than the force |D12h| which moves the ions to the bend region A2. Hence, the ions can quickly move to the splay region A1.

In the case where the display section 10A has the corner portion C1 as shown in FIG. 12, the ions in the liquid crystal layer LQ can quickly be moved to the splay region if the rubbing direction of the alignment film is set in the range of 45° to 90° from the direction substantially perpendicular to the first end side E1, where the bend region A2 is disposed, toward the second end side where the splay region A1 is disposed.

FIG. 13 shows the case in which the liquid crystal display panel 10 has a corner portion C2 at which end sides of the display section 10A intersect, and bend regions A2 are disposed in the peripheral section 10B along both the end sides which intersect at the corner portion C2. In the case of the liquid crystal display panel 10 shown in FIG. 13, the bend regions A2 are positioned in the direction of 0° and the direction of 270°.

Consideration is now given to the case where the alignment film of the liquid crystal display panel 10 is rubbed in a direction in the range of 270° to 360° from the horizontal axis H. In this range of angles, both the horizontal component and vertical component of the rubbing direction D1 are substantially perpendicular to the first end sides E1 where the bend regions A2 are disposed. At this time, the ions, which have moved to the vicinity of the boundary between the display section 10A and peripheral section 10B, agglomerate at the corner portion C2 at which the first side ends E1, where the bend regions A2 are disposed, intersect.

Thus, in the case where the display section 10A has the corner portion C2 as shown in FIG. 13, if the rubbing direction D1 of the alignment film is set so as not to fall within the range of 45° relative to the direction of the corner portion C2, the ions in the liquid crystal layer do not agglomerate at the corner portion C2.

Specifically, in the liquid crystal display panel 10 shown in FIG. 10, the bend regions A2 are disposed along the two neighboring sides of the display section 10A. That is, the liquid crystal display panel 10 has two corner portions C1 and one corner portion C2, as shown in FIG. 10.

At this time, like the above-described case, as regards the region where the corner portion C1 is positioned, the rubbing direction D1 of the alignment film is set in the range of 45° to 90° from the direction substantially perpendicular to the end side, where the bend region A2 is disposed, toward the end side where the splay region A1 is disposed. In addition, as regards the region where the corner portion C2 is positioned, the rubbing direction D1 of the alignment film is set so as not to fall within the range of ±45° relative to the direction of the corner portion C2.

Thus, in the case where the bend regions A2 are disposed as shown in FIG. 10, the rubbing direction D1 of the alignment film is set in the range of 45° to 225° from the horizontal axis H, that is, the rubbing direction D1 is set to a direction extending from the first end side E1 to the second end side E2 within the range of 45° relative to the line perpendicular to the second end side E2.

At this time, even in the case where the ions in the liquid crystal layer LQ have moved to the vicinity of the end side of the display section 10A where the bend region A2 is disposed, the ions do not agglomerate in the vicinity of the boundary between the display section 10A and peripheral section 10B and the ions can quickly be diffused into the splay region A1 of the peripheral section 10B.

In the liquid crystal display panel 10 shown in FIG. 11, the bend regions A2 are disposed along the three neighboring sides of the display section 10A. That is, the liquid crystal display panel 10 has two corner portions C1 and two corner portions C2, as shown in FIG. 11.

At this time, too, as regards the region where the corner portion C1 is positioned, the rubbing direction D1 of the alignment film is set in the range of 45° to 90° from the direction substantially perpendicular to the end side of the display section 10A, where the bend region A2 is disposed, toward the end side where the splay region A1 is disposed. In addition, as regards the region where the corner portion C2 is positioned, the rubbing direction D1 of the alignment film is set so as not to fall within the range of ±45° relative to the direction of the corner portion C2.

Thus, in the case where the bend regions A2 are disposed as shown in FIG. 11, the rubbing direction D1 of the alignment film is set in the range of 45° to 135° from the horizontal axis H, that is, the rubbing direction D1 is set to a direction extending from the first end side E1 to the second end side E2 within the range of 45° relative to the line perpendicular to the second end side E2.

Even in the case where the ions in the liquid crystal layer LQ have moved to the vicinity of the end side of the display section 10A where the bend region A2 is disposed, the ions do not agglomerate in the vicinity of the boundary between the display section 10A and peripheral section 10B and the ions can quickly be diffused into the splay region A1 of the peripheral section 10B.

Further, in the case where the bend regions A2 are disposed as shown in FIG. 10, it is preferable to set the rubbing direction D1 of the alignment film in the range of 90° to 180° from the horizontal axis. Thereby, the peripheral section 10B, which is an extension region in the rubbing direction D1, becomes a region where the bend region A2 is not present.

At this time, since the component of the rubbing direction D1, which is substantially perpendicular to the end side where the bend region A2 is disposed, is absent, the component of the direction, which is substantially perpendicular to the end side where the splay region A1 of the display section 10A is disposed, becomes greater than the component of the direction which is substantially perpendicular to the end side where the bend region A2 is disposed. Accordingly, the ions, which have moved to the vicinity of the boundary between the display section 10A and peripheral section 10B, are diffused, without agglomeration, into the splay region A1 of the peripheral section 10B.

Moreover, in the case where the bend regions A2 are disposed as shown in FIG. 11, it is preferable to set the rubbing direction of the alignment film at 90° from the horizontal axis. Thereby, the peripheral 5 section 10B, which is an extension region in the rubbing direction, becomes a region where the bend region A2 is not present. Accordingly, the ions, which have moved to the vicinity of the boundary between the display section 10A and peripheral section 10B, are diffused, without agglomeration, into the splay region of the peripheral section 10B.

Therefore, the present embodiment can provide an OCB mode liquid crystal display device which suppresses a display defect, such as non-uniform display, due to non-uniformity of ions in the liquid crystal layer, and has high display quality and high reliability.

The present invention is not limited directly to the above-described embodiments. In practice, the structural elements can be modified without departing from the spirit of the invention.

Various inventions can be made by properly combining the structural elements disclosed in the embodiments. For example, some structural elements may be omitted from all the structural elements disclosed in the embodiments. Furthermore, structural elements in different embodiments may properly be combined.

What is claimed is:

1. A liquid crystal display device of an OCB mode comprising a liquid crystal layer held between a first substrate and a second substrate, a display section composed of a plurality of display pixels arrayed in a matrix, and a peripheral section surrounding the display section,
wherein the first substrate includes pixel electrodes which are disposed in association with the plurality of display pixels,
the second substrate includes a counter-electrode which is opposed to the plurality of pixel electrodes,
the liquid crystal display device includes a pair of alignment films which are disposed on the plurality of pixel electrodes and the counter-electrode, respectively, the pair of alignment films controlling, by rubbing treatment, an alignment state of liquid crystal molecules included in the liquid crystal layer, and
the peripheral section includes a splay region, which splay-aligns the liquid crystal molecules, at least on a terminal-end side in a rubbing direction of the alignment film.

2. The liquid crystal display device according to claim 1, wherein in the splay region, the first substrate includes an electrically conductive layer which is opposed to the counter-electrode and has a potential substantially equal to a potential of the counter-electrode.

3. The liquid crystal display device according to claim 1, wherein the peripheral section includes a bend region which bend-aligns the liquid crystal molecules, and the splay region is disposed between the display section and the bend region.

4. The liquid crystal display device according to claim 3, wherein the first substrate includes, in the bend region, a wiring line which is opposed to the counter-substrate and to which a potential different from a potential applied to the counter-substrate is applied, and the first substrate includes, in the splay region, an electrically conductive layer which is opposed to the counter-electrode, and
the electrically conductive layer includes a guide path which extends over the wiring line to an outside of the bend region.

5. The liquid crystal display device according to claim 4, wherein the electrically conductive layer is set at a potential substantially equal to a potential of the counter-electrode.

6. The liquid crystal display device according to claim 2, wherein the first substrate includes, in the splay region, a wiring line to which a potential different from a potential of the counter-substrate is applied, and
the electrically conductive layer is disposed to cover the wiring line via an insulation layer.

7. A liquid crystal display device of an OCB mode comprising a liquid crystal layer held between a first substrate and a second substrate, a display section composed of a plurality of display pixels arrayed in a matrix, and a peripheral section surrounding the display section,
wherein the first substrate includes pixel electrodes which are disposed in association with the plurality of display pixels, and a driver or a connection part of the driver, which is disposed in the peripheral section,
the second substrate includes a counter-electrode which is opposed to the plurality of pixel electrodes,
the liquid crystal display device includes a pair of alignment films which are disposed on the plurality of pixel electrodes and the counter-electrode, respectively, the pair of alignment films controlling, by rubbing treatment, an alignment state of liquid crystal molecules included in the liquid crystal layer, and
a direction of the rubbing treatment of the alignment film extends from a first end side, where the driver or the connection part of the driver is disposed, toward a second end side where neither the driver nor the connection part of the driver is disposed, and an angle between the direction of the rubbing treatment and a line perpendicular to the second end side is within a range of 45°.
